(19) United States
(12) Patent Application Publication
(10) Pub. No.: US 2023/0126182 A1
(43) Pub. Date: Apr. 27, 2023

(54) LIDAR SYSTEM AND VEHICLE

(71) Applicant: ROBERT BOSCH GMBH, Stuttgart (DE)

(72) Inventors: Frederik Ante, Lampertheim (DE); Markus Hippler, Stuttgart (DE); Markus Kienzle, Lehrensteinsfeld (DE); Remigius Has, Grafenau-Daetzingen (DE); Stefan Spiessberger, Weinstadt (DE)

(21) Appl. No.: 17/907,026

(22) PCT Filed: Mar. 12, 2021
(86) PCT No.: PCT/EP2021/056290

§ 371 Date: Oct. 19, 2022

(30) Foreign Application Priority Data
Mar. 20, 2020 (DE) 10 2020 203 597.0

(51) Int. Cl. G01S 7/497; G01S 7/486; G01S 7/4912

(52) U.S. Cl. CPC G01S 7/497; G01S 7/486; G01S 7/4912

(57) ABSTRACT

A LIDAR system. The LIDAR system includes a light source and a bandpass filter which is situated in a reception path of the LIDAR system. The reception path being configured to receive light emitted by the light source which was reflected in surroundings of the LIDAR system. A spectral transmission width of the bandpass filter is configured to be narrower than a spectral emission width of a light beam emitted by the light source. A vehicle, which includes a LIDAR system, is also provided.

### FIELD

The present invention relates to a LIDAR system including a light source and a bandpass filter which is situated in a reception path of the LIDAR system, the reception path being configured to receive light emitted by the light source, which was reflected in surroundings of the LIDAR system, and to a vehicle including such a LIDAR system.

### BACKGROUND INFORMATION

Optical bandpass filters, preferably interference filters, are used in the reception path in present LIDAR systems to improve a signal-to-noise ratio in that background light is filtered out, and the useful radiation, in general laser radiation, is transmitted. To keep the influence of a background light on the signal-to-noise ratio as low as possible, the bandpass filter installed on the reception side should be as narrow as possible, i.e., allow as small as possible a wavelength range to pass. The filter bandwidth is generally selected in such a way that a majority of the emitted laser power is able to pass the bandpass filter again. For example, a laser having a spectral width of 10 nm may be used. The bandpass filter, however, must be even wider to capture tolerances of the emission wavelength of the laser to the central wavelength of the bandpass filter, angular dependencies of the filter, and tolerances of the temperature control. As a typical value, the bandpass filter would have to be approximately 15 nm wide to ensure, across all tolerances, that a large portion of the laser radiation is able to pass the filter.

Typical laser sources used in LIDAR systems are semiconductor lasers without wavelength stabilization, such as, for example, Fabry-Perot edge-emitting broad stripe lasers. This type of laser has been used in various systems for quite some time, which is why the technology is comparatively mature. Furthermore, these lasers have a high efficiency. A considerable disadvantage is the comparatively large spectral width of typically 8 nm to 10 nm, which, as was already mentioned, negatively affects the signal quality of a LIDAR system since a bandpass filter having a large spectral transmission width has to be used on the reception side. Due to tolerances (for example, the central wavelength), the spectral emission width is even greater than the spectral width of the laser itself, typically 12 nm to 18 nm.

Mainly in the telecommunications field, it is customary to control the temperature of semiconductor lasers to avoid temperature effects, such as, for example, a wavelength drift. The temperature control may be implemented, for example, by heating elements or by Peltier elements.

### SUMMARY

According to the present invention, a LIDAR system is provided in which a spectral transmission width of the bandpass filter is configured to be narrower than a spectral emission width of a light beam emitted by the light source.

The LIDAR system according to the present invention may have the advantage that, even though optical signal power is curtailed, the above-described advantages of the simpler laser source prevail, and the influence of the background light is hereby reduced.

According to an example embodiment of the present invention, it is preferred that the spectral transmission width is no greater than 95% of the spectral emission width. It is further preferred that the spectral transmission width is no greater than 90% of the spectral emission width. It is further preferred that the spectral transmission width is no greater than 80% of the spectral emission width. It is further preferred that the spectral transmission width is no greater than 70% of the spectral emission width. It is further preferred that the spectral transmission width is no greater than 60% of the spectral emission width. It is further preferred that the spectral transmission width is no greater than 50% of the spectral emission width. However, it is preferred at the same time that the spectral transmission width is greater than 5% of the spectral emission width. It is further preferred that the spectral transmission width is greater than 10% of the spectral emission width. It is further preferred that the spectral transmission width is greater than 20% of the spectral emission width. It is further preferred that the spectral transmission width is greater than 30% of the spectral emission width. It is further preferred that the spectral transmission width is greater than 40% of the spectral emission width. The spectral emission width of the light source may preferably range between 8 nm and 15 nm, preferably between 8 nm and 12 nm. The spectral transmission width may preferably be approximately 10 nm, preferably when the spectral emission width is approximately 15 nm. The influence of the background light is then reduced particularly well.

In some specific embodiments of the present invention, the LIDAR system is configured to adapt a temperature control of the light source to a temperature-dependent change of the bandpass filter. It is preferred that the temperature-dependent change of the bandpass filter is a temperature-dependent spectral shift. The background is that some filters have a temperature drift of up to 0.1 nm/K, which in the case of perfect temperature stabilization of the light source would cause central wavelengths of the light source and of the bandpass filter to diverge. The reason is that it is preferred that the central wavelength of the light source and the central wavelength of the bandpass filter agree.

For this reason, it is provided in some specific embodiments of the present invention that the LIDAR system includes a temperature stabilization unit, which is configured to regulate the temperature control of the light source in such a way that the central wavelength of the light source agrees with the central wavelength of the bandpass filter. This means that the laser, in such specific embodiments, is configured to be controllable, as a function of the temperature of the bandpass filter, to a temperature at which the central wavelengths of the light source and of the bandpass filter match. Preferably, a laser which particularly preferably has a comparatively large spectral emission width is used as the light source since such light sources are cost-effectively manufacturable. Typically, edge-emitting lasers without wavelength stabilization are used in LIDAR systems operating with short pulses. These light sources typically have a spectral width of approximately 8 nm to 12 nm. A temperature drift of the central wavelength of the light source is typically 0.3 nm/K. If the LIDAR system is to function over a large temperature range, the influence of the temperature dependence on the spectral width is so great that a temperature stabilization becomes necessary. For example, a 30 nm drift of the central wavelength of the light source may occur over a temperature range of 100 K without temperature stabilization, which is to be avoided as much as possible.

In some specific embodiments of the present invention, the temperature stabilization unit thus includes a heating element or a Peltier element to regulate the temperature control of the light source. In this way, it is possible to counteract the drift of the central wavelength of the light source and, at the same time, also to compensate for the drift of the central wavelength of the bandpass filter.

According to an example embodiment of the present invention, it is preferred that the temperature stabilization unit includes a temperature sensor to measure a present operating temperature of the bandpass filter. In this way, it is possible, during operation of the LIDAR system, to determine the temperature of the bandpass filter continuously or at intervals, and to suitably adapt the temperature control of the light source. It is furthermore preferred that the LIDAR system includes a control unit, which is configured to regulate the temperature control of the light source based on the measured operating temperature of the bandpass filter. A control unit shall be understood to mean an electrical device or control device which processes sensor signals, here of the temperature sensor, and, as a function thereof, outputs control signals, here to the temperature stabilization unit, to preferably control the heating element or the Peltier element. A divergence of the central wavelength of the bandpass filter and of the central wavelength of the light source may be counteracted well by this control.

In specific embodiments of the present invention, the LIDAR system includes a rotatably attached mirror to effectuate a beam deflection. The beam deflection is preferably a horizontal beam deflection, but may alternatively be a vertical beam deflection. In this way, the light emitted by the light source may be reflected in a plurality of directions into the surroundings, without the light source itself having to be configured to be rotatable. The rotatably attached mirror is preferably rotatably attached with respect to the light source and with respect to a light detector of the LIDAR system, the light source and the light detector preferably being situated torque-proof with respect to one another. A so-called “rotating mirror LIDAR system” is thus a preferred LIDAR system.

Some specific embodiments of the present invention provide that the LIDAR system includes a rotatably attached platform carrying a transmission path, which includes the light source, and the reception path, to effectuate a beam deflection. The beam deflection is preferably a horizontal beam deflection, but may alternatively be a vertical beam deflection. In this way, the LIDAR system including the transmission path and the reception path may be configured to be rotatable as a whole, in order to reflect the light emitted by the light source in a plurality of directions into the surroundings. In such exemplary embodiments, the light source and the light detector are thus preferably attached to be jointly rotatable and are situated torque-proof with respect to one another. A so-called “rotating platform LIDAR system” is thus another preferred LIDAR system.

Specific embodiments of the present invention provide that the LIDAR system is configured to emit a laser line with the aid of the light source, and to generate an optical image with the aid of the reception path, a line detector being provided in the reception path to generate the optical image. Such arrangements may allow the surroundings to be scanned well in LIDAR systems, and a more complex area detector may be dispensed with.

In some specific embodiments of the present invention, the LIDAR system may include a further bandpass filter in the transmission path, which is identical or similar to the above-described bandpass filter in the reception path. In this way, it may be ensured that the same amount of power, or not much more power, is emitted into the surroundings as may be used on the reception side again. The advantage of curtailing the spectrum already in the transmission path is that less power is emitted, which is advantageous for the eye safety, without having to curtail the spectral emission width of the light source itself, i.e., in particular, having to carry out structural changes to the light source.

According to the present invention, furthermore a vehicle is provided, including a LIDAR system of the type mentioned at the outset, the LIDAR system being electrically connected to a battery of the vehicle to operate the LIDAR system, a spectral transmission width of the bandpass filter being configured to be narrower than a spectral emission width of a light beam emitted by the light source.

The vehicle may have the advantage that, even though optical signal power is curtailed in the LIDAR system, the above-described advantages of the simpler light source prevail, and the influence of the background light is hereby reduced.

The vehicle may be a motor vehicle, in particular a road-bound motor vehicle, for example a passenger car or a truck or a two-wheeler.

Further advantages and specific embodiments of the motor vehicle are derived from the above comments with respect to the LIDAR system, to which reference is made here to avoid repetition.

Advantageous refinements of the present invention are disclosed herein.

### BRIEF DESCRIPTION OF THE DRAWINGS

Exemplary embodiments of the present invention are described in greater detail based on the figures and the following description.

FIG. 1 shows a first specific embodiment of the LIDAR system according to the present invention in a top view.

FIG. 2 shows a schematic illustration of a spectral transmission width B_{T} of the bandpass filter in the first specific embodiment, based on a spectral emission width B_{E} of a light beam emitted by the light source.

FIG. 3 shows a second specific embodiment of the LIDAR system according to the present invention in a top view.

### DETAILED DESCRIPTION OF EXAMPLE EMBODIMENTS

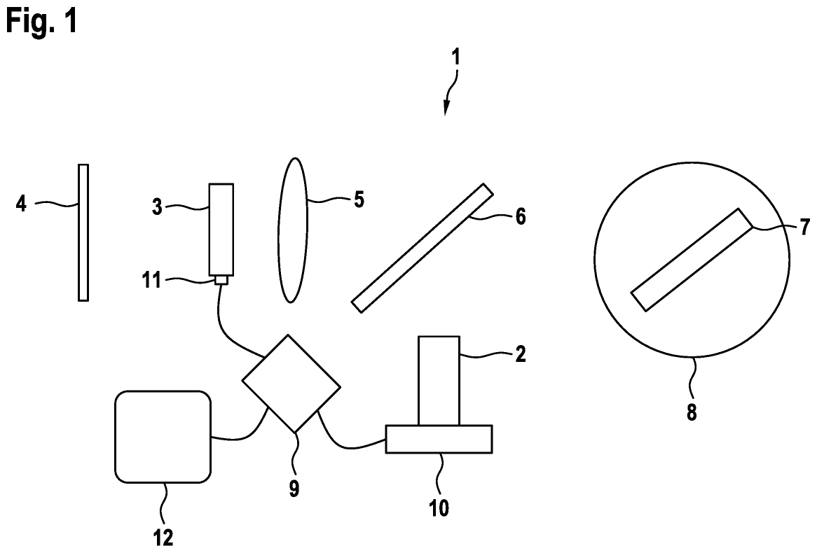

FIG. 1 shows a LIDAR system 1 in a first specific embodiment according to the present invention in a top view. LIDAR system 1 includes a light source 2 and a bandpass filter 3. Bandpass filter 3 is situated in a reception path of LIDAR system 1. The reception path is configured to receive light emitted by light source 2 which was reflected in surroundings of LIDAR system 1. For this purpose, the reception path includes a line detector 4, here, more precisely, a silicon photomultiplier (SiPM) array, and a beam shaping optics 5, here simplified as a collecting lens. In this exemplary embodiment, bandpass filter 3 is situated in the reception path between beam shaping optics 5 and line detector 4, but could also be situated in another location in the reception path, for example upstream from beam shaping optics 5.

In the first specific embodiment according to FIG. 1, LIDAR system 1 furthermore includes a fixed semipermeable mirror 6, which is configured to direct light emitted by light source 2 onto a rotatably attached mirror 7 of LIDAR system 1, here at a 90° angle, which in turn is configured to effectuate a beam deflection into the surroundings of LIDAR system 1, in the present exemplary embodiment a horizontal beam deflection into the surroundings. Rotatably attached mirror 7 is situated on a rotatable support plate 8, torque-proof with respect thereto. Rotatable support plate 8 is situated in an electromechanically rotatable manner with respect to light source 2 and line detector 4. This is thus a so-called “rotating mirror LIDAR system.” Semipermeable mirror 6 is furthermore configured to allow light which is incident again to pass to beam shaping optics 5 in the reception path. Semipermeable mirror 6 is thus situated both in the reception path and in the transmission path of LIDAR system 1.

In specific embodiments not shown, bandpass filter 3 or a further bandpass filter (not shown), which may have identical or similar properties as bandpass filter 3, may be situated upstream from semipermeable mirror 6 in the reception path, i.e., in particular, be situated between semipermeable mirror 6 and rotatably attached mirror 7. This means that bandpass filter 3 or the further bandpass filter may be situated both upstream from semipermeable mirror 6 in the reception path and at the same time also downstream from semipermeable mirror 6 in the transmission path.

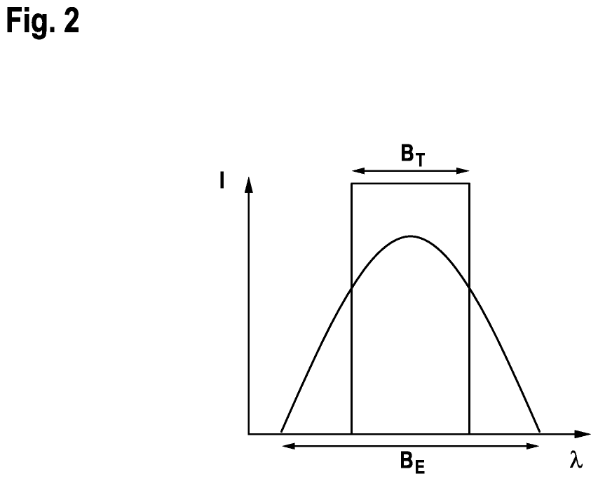

A spectral transmission width of bandpass filter 3 is configured to be narrower than a spectral emission width of a light beam emitted by light source 2. A significant portion of the optical power is laterally curtailed by bandpass filter 3, and only a portion of the optical power is transmitted. More precisely, the spectral transmission width, denoted by B_{T}, is no greater than 95% of the spectral emission width, denoted by B_{E}, as is apparent in FIG. 2. Wavelength A of the light beam is plotted on the x axis of the schematic diagram shown in FIG. 2, and intensity I of the light beam as a function of wavelength λ is plotted on the y axis. Spectral transmission width B_{T} is approximately greater than 40% and no greater than 60% of spectral emission width B_{E}. The fractions of the received light wavelength which are outside spectral transmission width B_{T} are not transferred to line detector 4. In this way, even though the spectrum of the light beam emitted by light source 2 is curtailed in the reception path before striking line detector 4, background light may be filtered out better, which, depending on the situation, may be more important for the proper functioning of LIDAR system 1.

LIDAR system 1 is furthermore configured to adapt a temperature control of light source 2 to a temperature-dependent change of bandpass filter 3. For this purpose, LIDAR system 1 includes a temperature stabilization unit 9, which is configured to regulate the temperature control of light source 2 in such a way that a central wavelength of light sources 2 agrees with a central wavelength of bandpass filter 3. The effect of this regulation is also apparent in FIG. 2. The maximum of intensity I, i.e., the central wavelength of light source 2, is namely at the same wavelength λ there as the central wavelength of spectral transmission width B_{T} of bandpass filter 3 illustrated as a rectangle. Temperature stabilization unit 9 includes a heating element 10 to regulate the temperature control of light source 2. Temperature stabilization unit 9 furthermore includes a temperature sensor 11 to measure a present operating temperature of bandpass filter 3. LIDAR system 1 includes a control unit 12, which is connected to temperature stabilization unit 9 for the data exchange and which is configured to evaluate the measurement of temperature sensor 11 and to control temperature stabilization unit 9, to operate heating element 10 in accordance with the measured temperature of bandpass filter 3, in order to regulate the temperature control of light source 2. In this way, the two central wavelengths remain in agreement over the time, even if the operating temperature of bandpass filter 3 changes. This may effectively prevent that, in particular, the maximum of intensity I of the light beam migrates out of the transmission width of bandpass filter 3 as a result of the temperature.

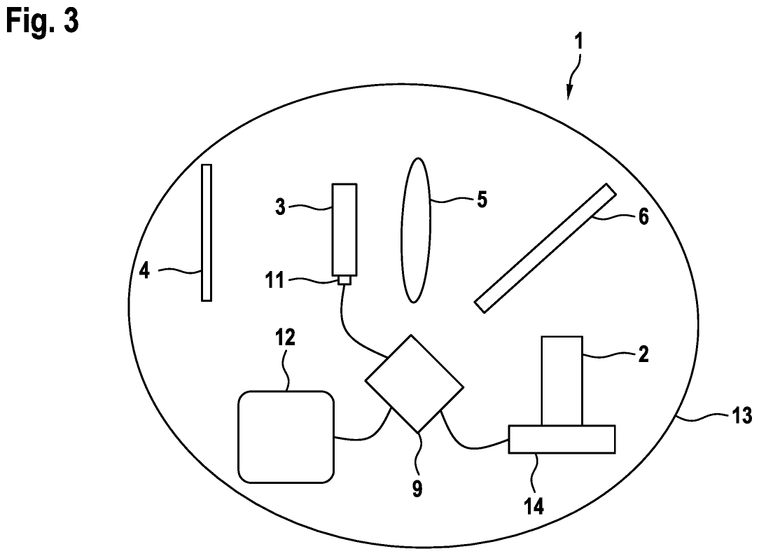

FIG. 3 finally shows a LIDAR system 1 in a second specific embodiment according to the present invention in a top view. In many respects, the design is identical to the design of the first specific embodiment from FIG. 1, which is why repetition is dispensed with. Bandpass filter 3 is again configured as explained based on FIG. 2. However, in the second specific embodiment LIDAR system 1, instead of the separately rotatably attached mirror 7 and support plate 8, includes a rotatable platform 13 carrying a transmission path, which includes light source 2, and the reception path to effectuate a beam deflection. In this exemplary embodiment, this is thus a so-called “rotating platform LIDAR system.” The beam deflection again takes place in the horizontal direction. In this exemplary embodiment, heating element 10 is replaced by a Peltier element 14, which also enables a cooling of light source 2.

In both specific embodiments, LIDAR system 1 is configured to emit a laser line with the aid of light source 2, and to generate an optical image with the aid of the reception path, line detector 4 being provided in the reception path to generate the optical image. In both specific embodiments, it is possible to use “standard lasers” as light source 2 in the reception path, even in the case of LIDAR systems 1 having narrow optical bandpass filters 3, i.e., a small spectral transmission width compared to the spectral emission width of light source 2. In other words, bandpass filter 3 is narrower than the spectral width (including all tolerances) of the radiation emitted by light source 2. Both specific embodiments are situated in a vehicle not shown in greater detail, LIDAR system 1 in each case being electrically connected to a battery (not shown) of the vehicle to operate LIDAR system 1.

The two specific embodiments illustrate that a laser having a wide emission spectrum may be used as light source 2 to be able to use an efficient (and/or already available) laser. The laser may be thermally stabilized, in particular, as a function of the operating temperature of the reception-side bandpass filter 3.

Although the present invention was illustrated and described in greater detail by preferred exemplary embodiments, the present invention is not limited by the described examples and other variations may be derived therefrom by those skilled in the art without departing from the scope of protection of the present invention.

1-10. (canceled)

11. A LIDAR system, comprising:
a light source; and
a bandpass filter situated in a reception path of the LIDAR system, the reception path being configured to receive light emitted by the light source, which was reflected in surroundings of the LIDAR system;
wherein a spectral transmission width of the bandpass filter is configured to be narrower than a spectral emission width of a light beam emitted by the light source.

12. The LIDAR system as recited in claim 11, wherein the spectral transmission width is no greater than 95% of the spectral emission width.

13. The LIDAR system as recited in claim 11, wherein the LIDAR system is configured to adapt a temperature control of the light source to a temperature-dependent change of the bandpass filter.

14. The LIDAR system as recited in claim 13, further comprising:
a temperature stabilization unit configured to regulate the temperature control of the light source in such a way that a central wavelength of the light sources agrees with a central wavelength of the bandpass filter.

15. The LIDAR system as recited in claim 14, wherein the temperature stabilization unit includes a heating element or a Peltier element to regulate the temperature control of the light source.

16. The LIDAR system as recited in claim 14, wherein the temperature stabilization unit includes a temperature sensor configured to measure a present operating temperature of the bandpass filter.

17. The LIDAR system as recited in claim 11, further comprising:
a rotatably attached mirror to effectuate a beam deflection.

18. The LIDAR system as recited in claim 11, further comprising:
a rotatably attached platform carrying a transmission path, which includes the light source, and the reception path, to effectuate a beam deflection.

19. The LIDAR system as recited in claim 11, wherein the LIDAR system is configured to emit a laser line using the light source, and to generate an optical image using the reception path, a line detector being provided in the reception path to generate the optical image.

20. A vehicle, comprising:
a LIDAR system including:
a light source, and
a bandpass filter situated in a reception path of the LIDAR system, the reception path being configured to receive light emitted by the light source, which was reflected in surroundings of the LIDAR system,
wherein a spectral transmission width of the bandpass filter is configured to be narrower than a spectral emission width of a light beam emitted by the light source;
wherein the LIDAR system is electrically connected to a battery of the vehicle for operating the LIDAR system.
